(19) United States
(12) Patent Application Publication
(10) Pub. No.: US 2010/0325567 A1
(43) Pub. Date: Dec. 23, 2010

(54) Apparatus and Method For Graphically Visualizing and Configuring Patterns

(75) Inventors: Vadim Berestetsky, North York (CA); Dorian Birsan, Toronto (CA); Allen V. Chan, Markham (CA); Irum I. Godil, Toronto (CA)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/819,923

(22) Filed: Jun. 21, 2010

(30) Foreign Application Priority Data
Jun. 22, 2009 (CA) 2669606

(51) Int. Cl. G06F 3/048

(52) U.S. Cl. 715/764

(57) ABSTRACT

A method for graphically visualizing and configuring patterns includes displaying a high-level diagram representing a pattern. The high-level diagram may include graphical elements. These graphical elements may include concept elements representing concepts within the pattern, and relationship elements showing the relationships between the concept elements. The method may further provide functionality to enable a user to select the concept elements. Upon selecting a concept element, the method may display one or more GUI input elements to enable the user to input configuration data associated with the concept element. The method may then generate one or more artifacts associated with the concept elements. These artifacts may be configured with the configuration data previously input. A corresponding apparatus and computer program product are also disclosed and claimed herein.

### BACKGROUND

1. Field

This invention relates to software patterns, and more particularly to apparatus and methods for graphically visualizing and configuring software patterns.

2. Description of the Related Art

In the field of computer science, a “pattern” is a type of problem that occurs over and over again, and an abstract solution to the problem that can be used over and over again to solve the problem. Patterns can take on various different forms, including “design patterns,” “architectural patterns,” and “integration patterns.” A design pattern is a general reusable solution to a commonly occurring software design problem. The design pattern is typically not a finished design that is transformable directly into code, but rather a description or template to solve a problem that can be used in many different situations. By contrast, architectural patterns are software patterns that offer well-established solutions to architectural problems in software engineering. Architectural patterns are typically larger in scale than design patterns. Integration patterns, by contrast, are software patterns used to make disparate applications work together in a unified manner.

In many cases, a pattern is provided as two basic items: documentation for the pattern (what it does, how to use it) and a wizard that lets a user enter some configuration values that are used to generate a number of artifacts (web services, mediation flows, etc.). Because patterns describe relatively complex situations, patterns may be documented using both text and graphical images. Graphics may be used to convey the essence of the pattern, including the various participants and their relationships. Unfortunately, many tools provide wizards or configuration pages in which the pattern concepts and relationships are lost. The user only sees wizard pages on which to enter various configuration values, and loses the high-level representation of the pattern. In other words, there is almost no connection between the graphical representation of the pattern and the configuration of the pattern. Most of the high level concepts are lost and the user works at a very low, tool-specific level. This makes it very difficult for the user to understand what is being configured and what the implications are.

In view of the foregoing, what is needed is an improved apparatus and method for visualizing and configuring patterns. Specifically, apparatus and methods are needed to help a user to understand underlying pattern concepts and relationships when configuring a pattern. Further needed are apparatus and methods to help a user understand how generated artifacts relate to pattern concepts and vice versa.

### SUMMARY

The invention has been developed in response to the present state of the art and, in particular, in response to the problems and needs in the art that have not yet been fully solved by currently available apparatus and methods. Accordingly, the invention has been developed to provide an apparatus and method for graphically visualizing and configuring patterns. The features and advantages of the invention will become more fully apparent from the following description and appended claims, or may be learned by practice of the invention as set forth hereinafter.

Consistent with the foregoing, a method for visualizing and configuring patterns is disclosed herein. In one embodiment, such a method may include displaying a high-level diagram representing a pattern. The high-level diagram may include one or more graphical elements. These graphical elements may include concept elements representing concepts within the pattern, and relationship elements showing the relationships between the concept elements. The method may provide functionality to enable a user to select the concept elements. Upon selecting a concept element, the method may display one or more graphical user interface (GUI) input elements allowing the user to input configuration data associated with the concept element. Once configuration data has been received for each of the concept elements, the method may generate one or more artifacts associated with the concept elements. These artifacts may be configured in accordance with the configuration data.

A corresponding apparatus and computer program product are also disclosed and claimed herein.

### BRIEF DESCRIPTION OF THE SEVERAL VIEWS OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level diagram of one example of a pattern, in this example an enterprise service bus (ESB) pattern called a “service gateway” or “service proxy”;

FIG. 2 shows one example of a conventional wizard for entering configuration data associated with the service gateway pattern;

FIG. 3 shows one example of an improved wizard or tool for entering configuration data associated with the service gateway pattern;

FIG. 4 shows one method for selecting concept elements within the service gateway pattern;

FIG. 5 shows one example of a GUI input element for entering configuration data associated with a concept element;

FIG. 6 shows one method for displaying a sub-pattern associated with a concept element;

FIG. 7 is a low-level diagram of artifacts that may be generated for a pattern; and

FIG. 8 is a high-level block diagram showing various modules for visualizing and configuring patterns.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, certain aspects of the invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, certain aspects of the invention may take the form of a computer program product embodied in any tangible medium of expression having computer-usable program code stored in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of processes, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

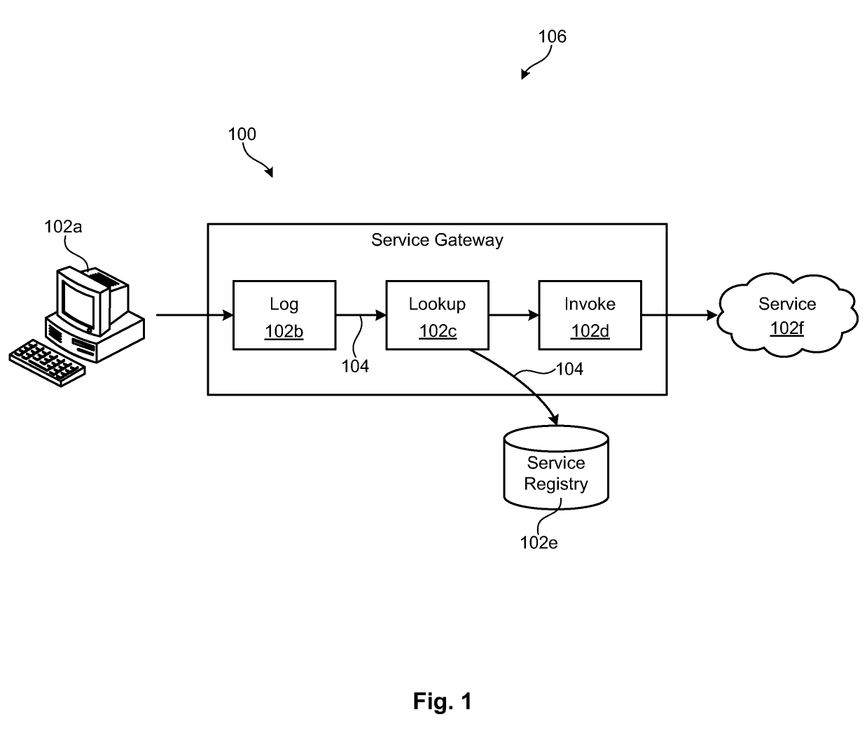

Referring to FIG. 1, a high-level diagram 106 of one example of a pattern 100 is illustrated. In this example, the pattern 100 is an enterprise service bus (ESB) pattern called a “service gateway” or “service proxy.” This pattern 100 is presented only by way of example to show the features and capabilities of the invention and is not intended to be limiting. Indeed, the apparatus and methods disclosed herein may be used with a wide variety of different patterns, including design patterns, architectural patterns, integration patterns, or the like, and are not limited to any one type or instance of pattern. Thus, nothing in this description should limit the embodiments of the invention to only the illustrated pattern 100.

Referring again to the pattern 100, an ESB service gateway (proxy) is configured to route a service call dynamically, based on lookup rules from a service registry, and optionally log all request and response messages. More specifically, the service gateway may act as a proxy to a variety of different services by providing a single entry point for incoming requests. All requesters may interact with a single endpoint address exposed by the gateway. The gateway is responsible for performing a common operation on every message and routing the request to the correct service provider.

As shown in FIG. 1, the pattern 100 may include one or more graphical elements to provide a high-level view of the participants in the pattern 100. These graphical elements may include concept elements 102, representing concepts (e.g., participants) within the pattern 100, and relationship elements 104 representing relationships between the concept elements 102. In this example, the concept elements 102 include a client 102a to generate a service call, a log component 102b to optionally log requests and responses, a lookup component 102c to look up service providers in a service registry 102e, an invocation component 102d to invoke a service, a service registry 102e to store a list of service providers, and a service 102f to be invoked. The relationship elements 104 in this example are simply arrows or connectors showing the communication or data flow between the concept elements 102.

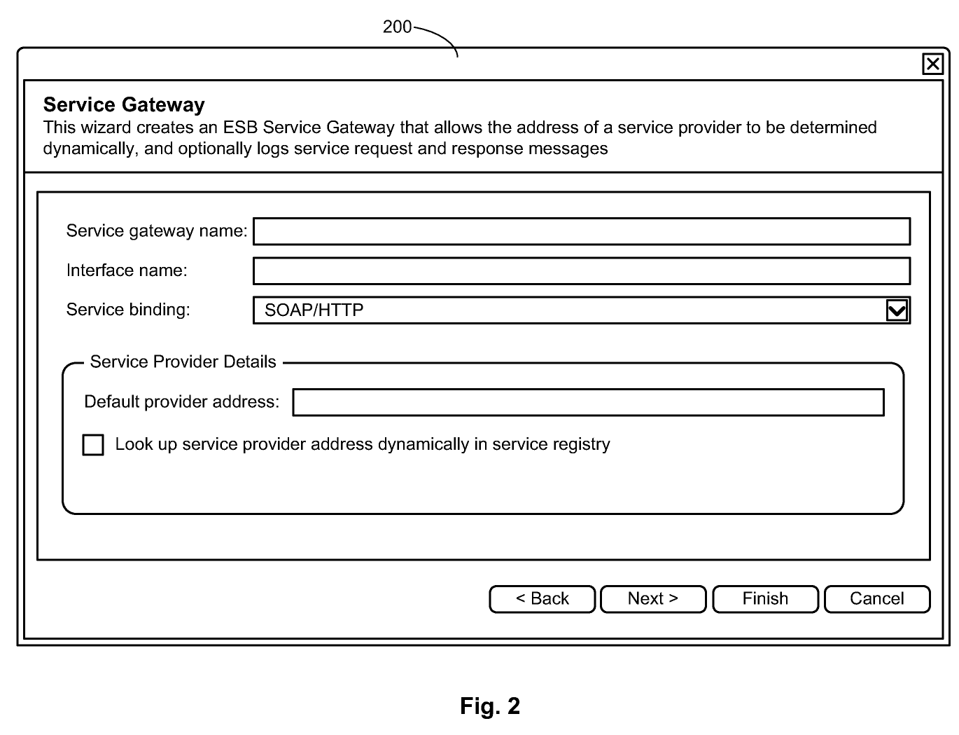

As previously mentioned, a pattern 100 may, in certain cases, include two basic items: documentation for the pattern 100 (which may include, for example, the high-level diagram 106) and a wizard that allows a user to enter configuration values associated with the pattern 100. These configuration values may be used to generate a number of artifacts associated with the pattern 100. Unfortunately, most wizards do not show the relationship between the configuration values and the pattern concepts and relationships. The user only sees wizard pages on which to enter various configuration values and loses the high-level representation of the pattern. For instance, FIG. 2 shows one example of a conventional wizard page 200. As shown, the wizard page 200 includes text boxes, a check box, and a pull down list to enter various configuration values, in this case “service gateway name,” “interface name,” “service binding,” and “default provider address” configuration values. Because the page 200 does not show or reference the pattern 100, it is difficult for the user to understand what is being configured and what the implications are when entering configuration values.

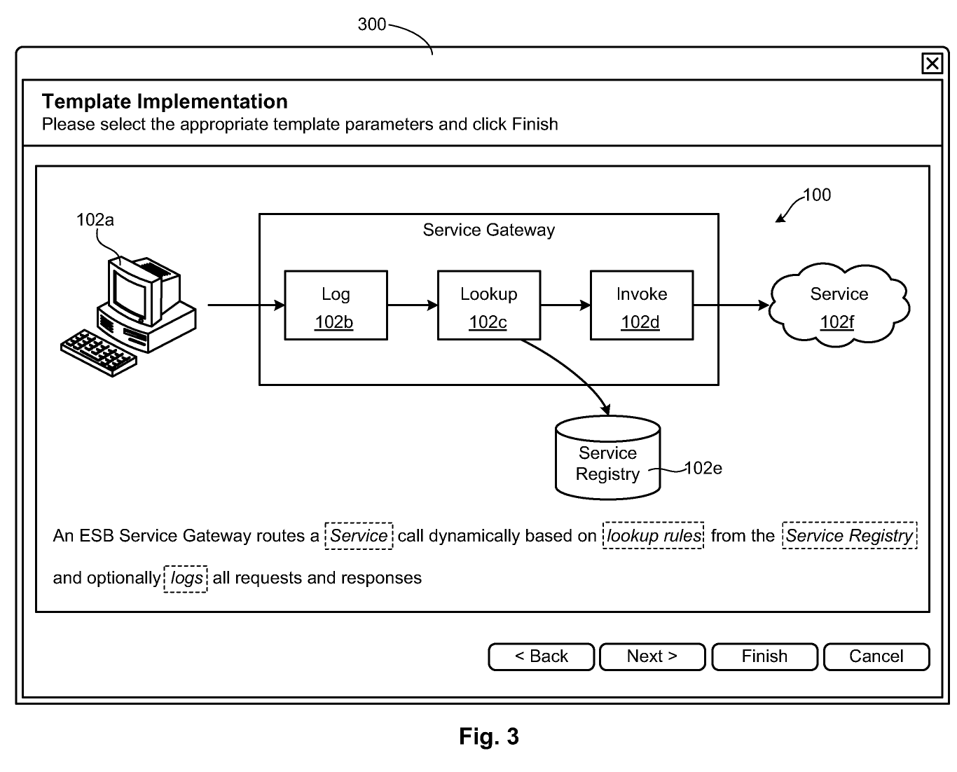

Referring to FIG. 3, in selected embodiments, an improved wizard 300 or tool 300 may provide a more intuitive way to visualize and configure patterns. In this example, the tool 300 includes a high-level diagram 106 of a pattern 100, in this case the service gateway pattern 100 previously described. The high-level diagram 106 provides a template or structure into which the user can enter the configuration values, allowing the user to work in a conceptual domain as opposed to a lower-level, tool-specific domain. The tool 300 may allow the user to select desired concept elements 102 and enter configuration values associated with the concept elements 102. This allows the user to visualize the pattern 100 and overarching concepts 102 of the pattern 100 when entering the configuration values, and educates the user regarding the relationship between the lower-level configuration values and high-level pattern concepts 102.

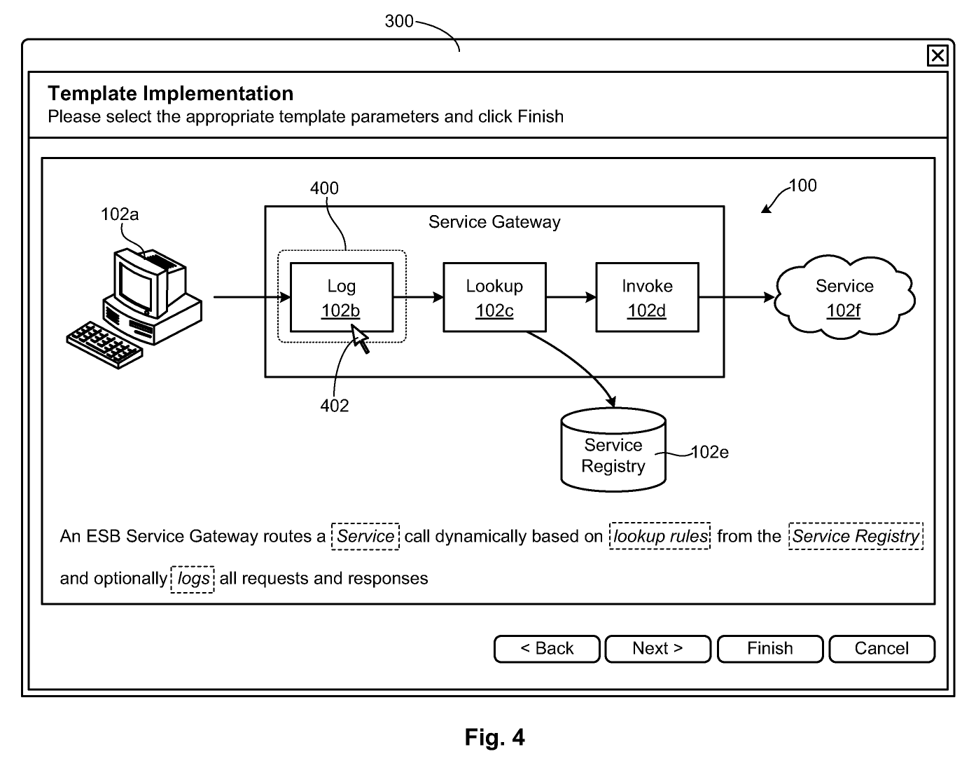

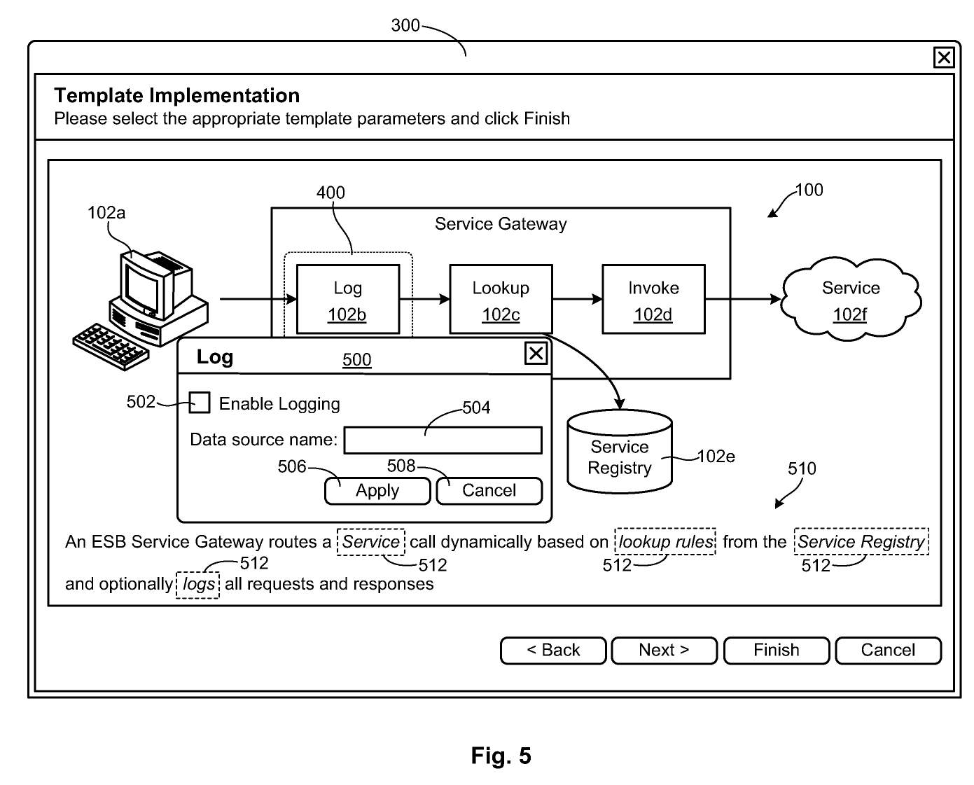

Referring to FIG. 4, in selected embodiments, the tool 300 may allow a user to hover over and click (with a mouse pointer 402 or other selection device) a desired concept element 102 to enter configuration values associated with the concept element 102. In certain embodiments, the concept elements 102 or areas immediately around the concept elements 102 may be configured as “hot spots” 400. In certain embodiments, upon selecting one of these “hot spots” 400, a graphical user interface (GUI) input element 500 may appear to allow the user to enter configuration values associated with the concept element 102. For example, as shown in FIG. 5, a GUI input element 500 containing a check box 502 and a text box 504 appears next to the “log” concept element 102b when a user clicks on the hot spot 400. In this example, the GUI input element 500 is a dialog box or window that allows the user to enable logging and enter a data source name associated with the logging operation. The user may then click an “apply” button 506 to accept the configuration values or a “cancel” button 508 to cancel the input operation. Other GUI widgets, such as combination boxes, drop-down lists, list boxes, radio buttons, scrollbars, sliders, or the like, may be used to input configuration values using the GUI input element 500.

Embodiments of the invention are not limited to the GUI input element 500 shown but may include other means or mechanisms for inputting data. For example, in other embodiments, the GUI input element 500 may include fields placed directly on or around the concept elements 102 rather than text or values entered into a dialog box or window. The user could enter configuration values by simply clicking on or selecting the fields and then entering configuration values into the fields. These configuration values could then be displayed directly on the concept elements 102 or in the area immediately around the concept elements 102. Other methods for inputting configuration values are also possible and within the scope of the invention. Thus, the phrase “GUI input element” is used broadly to include all types of input means or mechanisms.

Because patterns 100 may describe relatively complex situations, in certain embodiments patterns 100 may be documented using both text and graphical images. In selected embodiments, the tool 300 may also include text 510 that describes the operation of the pattern 100. This text 510 may enhance the user's understanding of the pattern 100 and optionally provide another way to enter configuration values. For example, the text 510 may provide key words 512 or hot spots 512 that a user could select to enter configuration values. Upon selecting one of the key words 512 or hot spots 512, a GUI input element 500, such as those previously described, could appear.

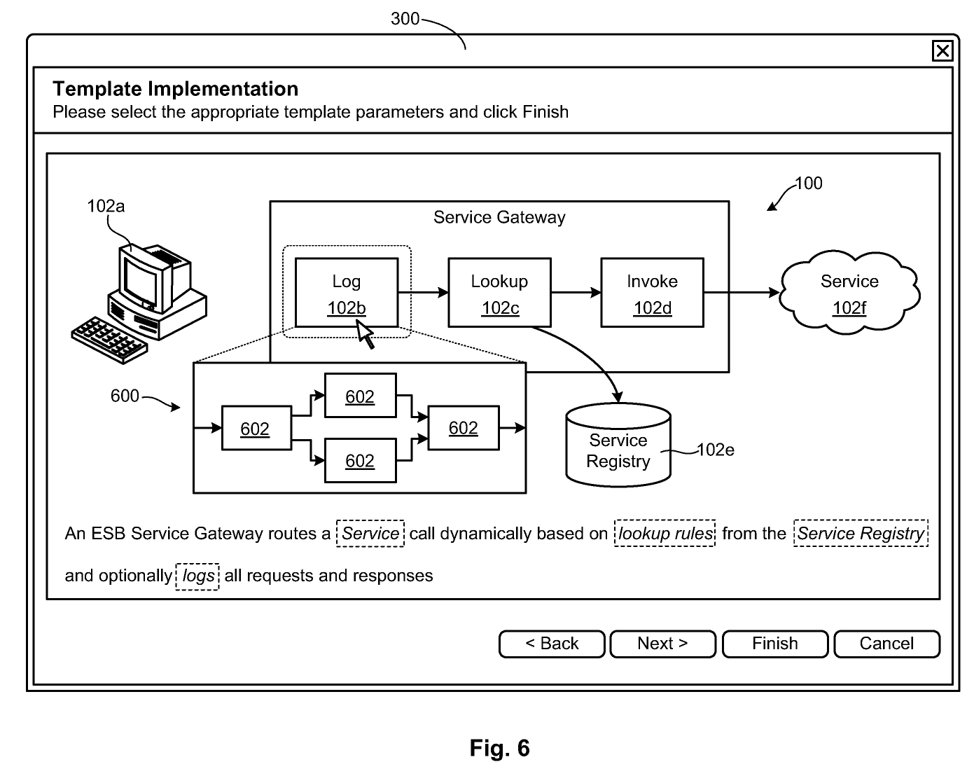

Referring to FIG. 6, in certain embodiments, the tool 300 may allow a user to drill down into selected concept elements 102 to reveal sub-patterns associated with the pattern concepts 102. For example, selecting a concept element 102b may reveal a sub-pattern 600 containing one or more sub-concepts 602 associated with the concept 102b. A user may select the sub-concepts 602 to enter configuration values in the previously described manner. Alternative, selecting a sub-concept 602 may reveal further sub-patterns and sub-sub-concepts. In this way, a user may drill down into a pattern 100 to reveal and configure various levels of sub-concepts 602.

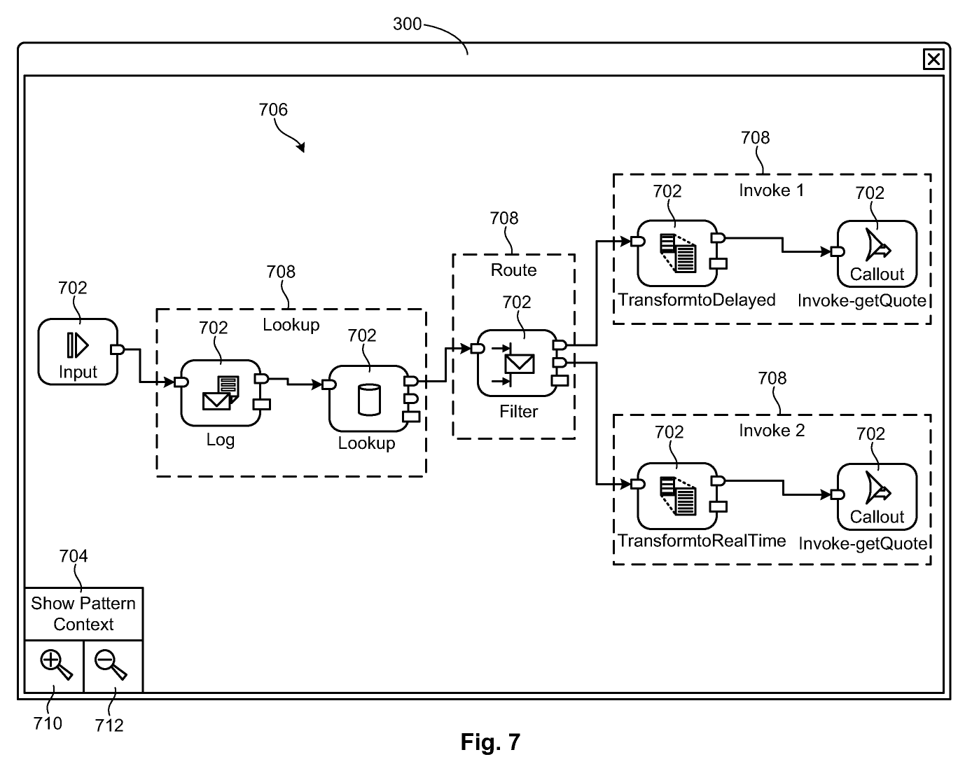

Referring to FIG. 7, once a user has entered any necessary configuration values for a pattern 100, the tool 300 may generate one or more artifacts 702 (e.g., web services, mediation flows, XML files, XSD files, java files, or the like) associated with the concept elements 102 and configured using the configuration values. In certain embodiments, these artifacts 702 may be represented graphically in a low-level diagram 706, as shown in FIG. 7. In selected embodiments, a pattern context function 704 may be provided to show the pattern context on the low-level diagram 706. For example, selecting the pattern context function 704 may cause a line 708 to be drawn around or overlaid on top of the artifacts 702 to show their relationship to particular concept elements 102. This helps the user understand the artifacts 702 and how they relate to the high-level pattern 100.

In certain embodiments, a “zoom-in” function 710 and “zoom-out” function 712 may be provided to understand the relationship between the high-level pattern 100 and lower-level artifacts 702. For example, a “zoom-in” function 710 may zoom-in with respect to various concept elements 102 to view artifacts 702 associated with the concept elements 102. Similarly, a “zoom-out” function 712 may zoom-out with respect to artifacts 702 to display concept elements 102 associated with the artifacts 702. In this way, the user can readily see the relationship between artifacts 702 and concept elements 102. In certain embodiments, the “zoom-in” and “zoom-out” functions 710, 712 may also allow the user to see what sub-patterns 600, if any, are associated with the concept elements 102. For example, zooming-in with respect to a concept element 102 may display sub-patterns 600 associated with the concept element 102 and then artifacts 702 associated with the sub-pattern concept elements 602. Similarly, zooming-out with respect to artifacts 702 may display sub-patterns 600 associated with the artifacts 702 and then higher-level concepts 102 associated with the sub-patterns 600.

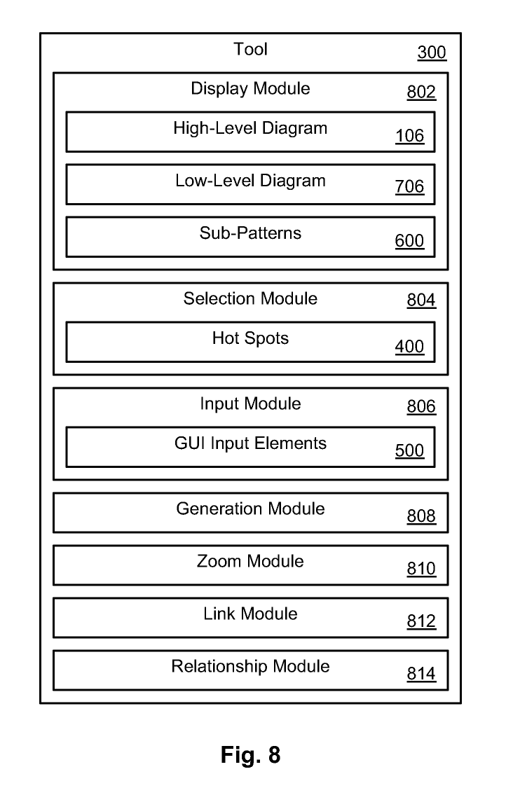

Referring to FIG. 8, in certain embodiments, a tool 300 (or apparatus 300) may include one or more modules to implement the functionality described in FIGS. 3 through 7. These modules may be embodied in hardware, software configured to operate on hardware, firmware, or a combination thereof. In selected embodiments, these modules may include one or more of a display module 802, a selection module 804, an input module 806, a generation module 808, a zoom module 810, a link module 812, and a relationship module 814.

In certain embodiments, the display module 802 may be used to display a high-level diagram 106 of a pattern 100, allowing the user to graphically visualize the pattern 100 while generating related artifacts. As previously mentioned, this high-level diagram 106 may include graphical elements such as concept elements 102 and relationship elements 104, as described in association with FIG. 1. A selection module 804 may allow the user to select one or more concept elements 102 from the high-level diagram 106. For example, the selection module 804 may allow the user to hover over and click on a desired concept element 102 to select it. In doing so, the selection module 804 may, in certain embodiments, provide “hot spots” 400 on or immediately around the concept elements 102 to enable selection by the user.

An input module 806 may provide functionality to allow the user to input configuration values associated with the concept elements 102. For example, the input module 806 may display one or more GUI input elements 500 when a user selects a particular concept element 102. In doing so, the input module 806 may provide GUI widgets such as dialog boxes, windows, check boxes, text boxes, combination boxes, drop-down lists, list boxes, radio buttons, scrollbars, sliders, or the like, to input configuration values. In other embodiments, the input module 806 may allow the user to enter configuration values by clicking on or selecting fields on or around the concept elements 102 and entering configuration values into the fields. These configuration values may then be displayed as text, numbers, or graphics on the concept elements 102 or in areas immediately around the concept elements 102. In general, the input module 806 may use any suitable technique or mechanism for inputting data.

Once a user has entered the required configuration values, a generation module 808 may generate a set of low-level artifacts 702 associated with the concept elements 102. These artifacts 702 may be configured in accordance with the configuration values previously entered. In certain embodiments, the display module 802 may be configured to display the artifacts graphically as a low-level diagram 706, as shown in FIG. 7. A zoom module 810 may allow a user to zoom-in with respect to concept elements 102 to view artifacts 702 associated with the concept elements 102, or zoom-out with respect to artifacts 702 to view concept elements 102 that are associated with the artifacts 702, as previously described. In doing so, the zoom module 810 may, in certain embodiments, display sub-patterns 600 that are associated with the concept elements 102 and artifacts 702.

A link module 812 may maintain a logical link between concept elements 102 and associated artifacts 702. For example, the link module 812 may ensure that changes that are made at the conceptual level are reflected at the artifact level and vice versa. A relationship module 814 may show the relationship between generated artifacts 702 and concepts 102. For example, the relationship module 814 may cause a line 708 to be drawn around or overlaid on top of artifacts 702 to show their relationship to particular concept elements 102, as described in association with FIG. 7. This will help the user understand the artifacts 702 and how they relate to higher-level concepts 102.

The flowchart and block diagrams in the Figures illustrate the architecture, functionality, and operation of possible implementations of systems, processes, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

What is claimed is:

1. A method operable by a computer for graphically visualizing and configuring patterns, the method comprising:
the computer displaying a high-level diagram representing a pattern, the high-level diagram comprising a plurality of graphical elements, the plurality of graphical elements comprising concept elements representing concepts within the pattern, and relationship elements representing relationships between the concept elements;
the computer providing functionality to enable a user to select the concept elements;
the computer displaying, in response to user selections, graphical user interface (GUI) input elements to enable the user to input configuration data associated with the concept elements; and
the computer generating artifacts associated with the concept elements and configured in accordance with the configuration data.

2. The method of claim 1, further comprising providing functionality to enable the user to zoom-in with respect to the concept elements in order to view the artifacts associated with the concept elements.

3. The method of claim 1, further comprising providing functionality to enable the user to zoom-out with respect to the artifacts in order to display the concept elements associated with the artifacts.

4. The method of claim 1, wherein the pattern comprises at least one of a design pattern, an architectural pattern, and an integration pattern.

5. The method of claim 1, further comprising displaying, in response to the user selections, sub-patterns associated with the concept elements.

6. The method of claim 5, further comprising providing functionality to enable the user to select a concept element from the sub-patterns.

7. The method of claim 6, further comprising displaying GUI input elements allowing the user to input the configuration data associated with the concept element selected from the sub-patterns.

8. The method of claim 1, further comprising displaying a low-level diagram showing the artifacts and the relationships between the artifacts.

9. The method of claim 8, further comprising showing, on the low-level diagram, the relationships between the artifacts and the concept elements.

10. The method of claim 1, further comprising maintaining logical links between the concept elements and the artifacts, thereby allowing changes made to the concept elements to be reflected in the artifacts.

11. A computer program product for graphically visualizing and configuring patterns, the computer program product comprising a computer-usable storage medium having computer-usable program code stored therein, the computer-usable program code comprising:
computer-usable program code to display a high-level diagram representing a pattern, the high-level diagram comprising a plurality of graphical elements, the plurality of graphical elements comprising concept elements representing concepts within the pattern, and relationship elements representing relationships between the concept elements;
computer-usable program code to enable a user to select the concept elements;
computer-usable program code to display, in response to user selections, graphical user interface (GUI) input elements to allow the user to input configuration data associated with the concept elements; and
computer-usable program code to generate artifacts associated with the concept elements and configured in accordance with the configuration data.

12. The computer program product of claim 11, further comprising computer-usable program code to enable the user to zoom-in with respect to the concept elements to view the artifacts associated with the concept elements.

13. The computer program product of claim 11, further comprising computer-usable program code to enable the user to zoom-out with respect to the artifacts to display the concept elements associated with the artifacts.

14. The computer program product of claim 11, wherein the pattern comprises at least one of a design pattern, an architectural pattern, and an integration pattern.

15. The computer program product of claim 11, further comprising computer-usable program code to display, in response to the user selections, sub-patterns associated with the concept elements.

16. The computer program product of claim 15, further comprising computer-usable program code to enable the user to select a concept element from the sub-patterns.

17. The computer program product of claim 16, further comprising computer-usable program code to display GUI input elements allowing the user to input the configuration data associated with the concept element selected from the sub-patterns.

18. The computer program product of claim 11, further comprising computer-usable program code to display a low-level diagram showing the artifacts and the relationships between the artifacts.

19. The computer program product of claim 18, further comprising computer-usable program code to show, on the low-level diagram, the relationships between the artifacts and the concept elements.

20. The computer program product of claim 11, further comprising computer-usable program code to maintain logical links between the concept elements and the artifacts, thereby allowing changes made to the concept elements to be reflected in the artifacts.

21. An apparatus for graphically visualizing and configuring patterns on a display device, the apparatus comprising:
a display module to display on the display device a high-level diagram representing a pattern, the high-level diagram comprising a plurality of graphical elements, the plurality of graphical elements comprising concept elements representing concepts within the pattern, and relationship elements representing relationships between the concept elements;
a selection module to enable a user to select the concept elements;
an input module to display on the display device, in response to user selections, graphical user interface (GUI) input elements to enable the user to input configuration data associated with the concept elements; and
a generation module to generate artifacts associated with the concept elements that are configured in accordance with the configuration data.

22. The apparatus of claim 21, further comprising a zoom module to enable the user to zoom-in with respect to the concept elements to view the artifacts associated with the concept elements.

23. The apparatus of claim 22, wherein the zoom module is further configured to enable the user to zoom-out with respect to the artifacts to display the concept elements associated with the artifacts.

24. The apparatus of claim 21, wherein the display module is further configured to display, in response to the user selections, sub-patterns associated with the concept elements.

25. The apparatus of claim 21, wherein the display module is further configured to display a low-level diagram showing the artifacts and the relationships between the artifacts and the concept elements.
